(19) United States
(12) Patent Application Publication
(10) Pub. No.: US 2025/0263573 A1
(43) Pub. Date: Aug. 21, 2025

(54) WATER-BASED SOLID MARKING COMPOSITION

(71) Applicant: SOCIÉTÉ BIC, Clichy Cedex (FR)

(72) Inventor: Damien CONCEDIEU, Clichy Cedex (FR)

(73) Assignee: SOCIÉTÉ BIC, Clichy Cedex (FR)

(21) Appl. No.: 18/705,291

(22) PCT Filed: Oct. 25, 2022
(86) PCT No.: PCT/EP2022/079683

§ 371 Date: Apr. 26, 2024

(30) Foreign Application Priority Data
Oct. 29, 2021 (EP) 21306524.6

(51) Int. Cl. C09D 13/00; C09D 7/63; C09D 7/80

(52) U.S. Cl. CPC C09D 13/00; C09D 7/63; C09D 7/80

(57) ABSTRACT

The present disclosure concerns a water-based solid marking composition comprising a) an alkali metal salt of carboxylic acid having 8 to 36 carbon atoms; (b) a fatty acid amide and (c) a coloring agent. The solid water-based marking compositions may be used for drawing or marking and can be in form of a crayon, a pastel crayon, a stick or a colored pencil.

### CROSS-REFERENCE TO RELATED APPLICATIONS

This is a National Stage Application under 35 U.S.C. § 371 of International Application No. PCT/EP2022/079683, filed Oct. 25, 2022, now published as WO 2023/072883 A1, which claims priority to the European Patent Application No. 21306524.6, filed Oct. 29, 2021, the entireties of which are incorporated herein by reference

### TECHNICAL FIELD

The present disclosure concerns solid water-based marking compositions which may be used for drawing or marking and that can be in form of a crayon, a pastel crayon, a stick or a colored pencil.

### BACKGROUND

Conventional oil-based marking compositions such as wax-based coloring crayon (also known as wax crayon or wax pastel) do not have a good affinity with paper and therefore are hard to apply on it, while at the same time leaving sludge on paper and expressing poor color tone.

Water-based solid marking composition containing alkali metal salt of carboxylic acid having 8 to 36 carbon atoms are already known such as in EP1342761 and U.S. Pat. No. 5,725,642. However, the inventors have surprisingly found that the addition of fatty acid amide improves the smoothness of said water-based solid marking composition, as well as the quality deposit.

Thus, the water-based solid marking composition according to the disclosure enable a smooth feeling when applying the composition on a paper surface while avoiding at the same time some common difficulties of liquid inks such as stability, for example sedimentation of particles that could be present in the ink, in particular if these have a D50 of about 10 μm or more, or such as ink leakage or clogging of the tip.

### SUMMARY

The inventors of the present disclosure have surprisingly found that the water-based solid marking composition according to the disclosure is endowed with high smoothness and enables to obtain a written mark of improved quality (such as regularity, and/or uniformity and/or a well-defined outline), in particular on a porous support. In addition according to some embodiments, the solid composition according to the disclosure is advantageously stable over time, in particular after being stored during one month at room temperature or at 40° C. or even after 6 months at room temperature,

The present disclosure therefore concerns a water-based solid marking composition comprising
a) an alkali metal salt of carboxylic acid having 8 to 36 carbon atoms;
b) a fatty acid amide and
c) a coloring agent.

The water-based solid marking composition according to the disclosure exhibits a high smoothness, in particular it is soft and easy to apply (good lay-down), in particular on a porous surface such as paper, and with a satisfactory glide, in particular with no feel of friction by the user.

Besides, the water-based solid marking composition according to the disclosure enables to obtain a written mark of improved quality, in particular in terms of regularity, more specifically when applied on a porous surface such as paper. More specifically the obtained written mark exhibits good uniformity (in particular no or very few blank areas) and/or a well-defined outline.

In some embodiments, the water-based solid marking composition according to the disclosure is advantageously stable over time, in particular after being stored during one month at room temperature or at 40° C., or even after 6 months at room temperature, more specifically, no exudation and/or no crystallization phenomenon have been observed.

In some embodiments, the water-based solid marking composition according to the disclosure is advantageously of sufficient hardness, in particular it does not break during use, in particular when the composition is in form of a stick.

In some embodiments, the water-based solid marking composition according to the disclosure is advantageously translucent.

In some embodiments, the water-based solid marking composition according to the disclosure advantageously enables to carry out a coloured transparent written mark on a porous support such as paper, more specifically a first written mark made on a paper surface before applying the solid water-based composition according to the disclosure on the top of such first written mark can still be observed by naked eye through the deposit of solid water-based composition according to the disclosure.

In some embodiments, the water-based solid marking composition according to the disclosure advantageously enables to obtain a glossy written mark on a porous support such as paper.

Advantageously, the water-based solid marking composition according to the disclosure is compatible with porous substrate, such as paper and skin.

### DETAILED DESCRIPTION

Hereinafter, a detailed description of the present disclosure will be given. The specific embodiments are meant to better illustrate the present disclosure, however, it should be understood that the present disclosure is not limited to these specific embodiments.

In the sense of the present disclosure, the expressions “comprising a” and “containing a” should be understood as being synonymous with respectively “comprising at least one” and “containing at least one”.

In the sense of the present disclosure, the expressions “between . . . and . . . ” or “ranging from . . . to . . . ” should be understood as including the values of the limits.

In the sense of the present disclosure the term “solid” characterizes the state of the composition at room temperature (25° C.) and at atmospheric pressure (760 mmHg). In particular the solid composition according to the disclosure can be in form of a stick, for example having a diameter of between 5 to 15 mm, more specifically between 8 to 14 mm.

Advantageously, the composition according to the disclosure has a hardness of between 30 and 300 g, or even from 50 to 200 g at room temperature (25° C.) and at atmospheric pressure (760 mmHg), in particular for a sample in form of a stick of 12.1 mm in diameter.

### Protocol for Measuring the Hardness:

The measurement can be performed according to the following protocol:

A sample of the composition under consideration is hot-cast into a stick mould of between 8 to 14 mm in diameter, more specifically of 12.1 mm. The mould is then cooled in a freezer for about one hour. The stick is then stored at 20° C.

The hardness of the samples is measured after an interval of 24 hours.

The hardness of the samples of compositions of the disclosure, expressed in grams, is measured using a DFGHS 2 tensile testing machine sold by the company Indelco-Chatillon.

The hardness corresponds to the maximum shear force exerted by a rigid tungsten wire 250 μm in diameter, advancing at a rate of 100 mm/minute.

The technique described above is usually referred to as the “cheese wire” method.

The solid marking composition according to the disclosure is indeed intended to be used for drawing and/or marking.

In a specific embodiment the water-based marking composition according to the disclosure is in the form of a crayon, a pastel crayon, a stick or a colored pencil, advantageously a stick.

The water-based marking composition according to the disclosure can be molded, cast or extruded; specifically it is molded, for example in a stick form, specifically having a diameter between 5 mm to 15 mm, more specifically between 8 to 14 mm.

For the purposes of the present disclosure, the term “porous substrate” is intended to mean substrate that contains pores. The porous substrates have empty spaces or pores that allow external matter, like marking composition, to penetrate into the substrate. In particular, writing surfaces such as white board or enamel board are not considered as writing porous substrate. In particular, the porous substrates are fibrous. For example, the “porous substrate” can be fabrics (such as flax, cotton) such as clothes, cellulosic fiber paper such as paper (printer paper, notebook paper or Clairefontaine paper (smooth paper) for example) and cardboard paper.

In the sense of the present disclosure the term “water-based composition” is intended to mean that is not water-free and thus comprises water, in particular as a solvent. More specifically the total content of water in the composition according to the disclosure is in the range of 1 to 50%, more specifically 2 to 30%, even more specifically 5 to 25%, still more specifically 7 to 15%, by weight based on the total weight of the composition.

The composition according to the present disclosure contains as component (a) an alkali metal salt of carboxylic acid having 8 to 36 carbon atoms, specifically an alkali metal salt of carboxylic acid having 12 to 36 carbon atoms, more specifically an alkali metal salt of carboxylic acid having 12 to 28 carbon atoms, specifically an alkali metal salt of fatty acid having 8 to 36 carbon atoms, more specifically an alkali metal salt of fatty acid having 12 to 36 carbon atoms, even more specifically an alkali metal salt of fatty acid having 12 to 28 carbon atoms, still more specifically an alkali metal salt of saturated linear fatty acid having 12 to 36 carbon atoms, more specifically 12 to 28 carbon atoms.

Specifically the alkali metal salt is selected in the group consisting of lithium salt, sodium salt, potassium salt, rubidium salt, caesium salt and francium salt, more specifically in the group consisting of lithium salt, sodium salt and potassium salt, even more specifically it is a sodium salt.

In a specific embodiment, the alkali metal salt of carboxylic acid having 8 to 36 carbon atoms (a) is an alkali metal salt of monocarboxylic acid having 8 to 36 carbon atoms, specifically an alkali metal salt of saturated fatty acid having 8 to 36 carbon atoms, more specifically an alkali metal salt of saturated fatty acid having 12 to 28 carbon atoms. Specific examples of saturated fatty acids according to the disclosure are caprylic acid, capric acid, lauric acid, myristic acid, palmitic acid, stearic acid, arachidic acid, behenic acid, lignoceric acid and cerotic acid, specifically the examples are lauric acid, myristic acid, palmitic acid, stearic acid, arachidic acid, behenic acid, lignoceric acid and cerotic acid, more specifically the saturated fatty acid is stearic acid.

Even more specifically, the component (a) has the following formula: R₄COOX in which R₄ represents a saturated alkyl group in C₇-C₃₅, more specifically in C₁₁-C₂₇, and X represents an alkali, in particular an alkali metal.

For the purposes of the present disclosure, the term “Cₓ-C_{y} alkyl group” is intended to mean any linear or branched alkyl group having from x to y carbon atoms.

In a specific embodiment, component (a) is sodium stearate.

Specifically, the total content of the alkali metal salt of carboxylic acid having 8 to 36 carbon atoms (a) in the composition according to the disclosure is in the range of 0.1 to 20%, more specifically 1 to 15%, still more specifically 2 to 15%, even still more specifically 4 to 10%, by weight based on the total weight of the composition.

In particular Component (a) has the function of a structuring agent in the composition according to the present disclosure.

The composition according to the present disclosure contains as component (b) a fatty acid amide. Specifically the fatty acid is saturated or unsaturated, more specifically saturated, even more specifically selected in the group consisting of caprylic acid, capric acid, lauric acid, myristic acid, palmitic acid, stearic acid, arachidic acid, behenic acid, lignoceric acid and cerotic acid, still more specifically in the group consisting of caprylic acid, capric acid, lauric acid, myristic acid, palmitic acid and stearic acid, even still more specifically in the group consisting of capric acid and stearic acid, advantageously it is capric acid.

In a specific embodiment, component (b) has the following formula (I) R₁CONR₂R₃, in which:
R₁ represents an alkyl or alkenyl group having from 5 to 18 carbon atoms, specifically an alkyl group, the alkyl or alkenyl group being optionally substituted by one or several groups selected among a chloro atom, a fluoro atom, a bromo atom, a nitro group, a nitrile group, an hydroxyl group, a thiol group, a carboxyl group, an ester group having 2 to 6 carbon atoms, a C₁₋₂₂-alkoxy group, C₆₋₁₄ aryl group, a C₇-C₂₀ alkaryl group, an amino group, an amino-C₁₋₂₂-alkyl group and an amino-di(C₁₋₂₂-alkyl) group, more specifically R₁ represents an unsubstituted alkyl or alkenyl group having from 5 to 18 carbon atoms, and
R₂ and R₃ independently from each other represent a hydrogen atom or a C₁-C₆ alkyl group, such as a methyl group, optionally substituted by a hydroxyl group and/or a C₁-C₂₂ alkoxy group, more specifically R₂ and R₃ independently from each other represent a hydrogen atom or an unsubstituted C₁-C₆ alkyl group, more specifically R₂ and R₃ independently from each other represent a C₁-C₆ alkyl group, still more specifically non-substituted, even still more specifically R₂ and R₃ represent both a methyl group. In a specific embodiment, R₂ or R₃ does not represent a hydrogen atom.

For the purpose of the present disclosure, the term “C₁₋₂₂-alkoxy group” is intended to mean any linear or branched alkoxy group having 1 to 22, carbon atoms, specifically the group OCH₃.

For the purpose of the present disclosure, the term “C₆₋₁₄ aryl group” is intended to mean one or more aromatic rings having 6 to 14 carbon atoms, which may be joined or fused. In particular, the aryl groups may be phenyl or naphthyl groups.

For the purpose of the present disclosure, the term “C₇-C₂₀ alkaryl group” is intended to mean any aryl group as defined above, linked via an alkyl group as defined above. In particular, an alkaryl group is a benzyl group.

The term “alkenyl” as used in the present disclosure refers to straight or branched chain alkenyl radicals including, but not limited to pentenyl, hexenyl and the like.

The term “ester group having 2 to 6 carbon atoms” as used in the present disclosure refers to straight or branched chain esters radicals having from 2 to 6 carbon atoms.

In a specific embodiment, component (b) is a dimethylamide, more specifically such as dimethylcapramide and dimethylstearamide, even more specifically it is dimethylcapramide.

In a specific embodiment, component (b) is selected in the group consisting of dimethylcapramide, capramide, stearamide and dimethylstearamide, more specifically in the group consisting of dimethylcapramide and dimethylstearamide, even more specifically it is dimethylcapramide.

More specifically, the total content of the fatty acid amide (b) in the composition according to the disclosure is in the range of 0.1 to 20%, more specifically 0.1 to 10%, still more specifically 0.2 to 5%, even still more specifically 1 to 5%, by weight based on the total weight of the composition.

The composition according to the present disclosure contains as component (c) a coloring agent. The coloring agent may be a pigment and/or a dye, more specifically it is a dye.

The term “dyes” should be understood as meaning colored, mineral or organic particles of any form, which are soluble in the medium in which they are solubilized (here water), and which are intended to color the solid marking composition. The at least one dye may be selected in the group consisting of direct dyes (for example C.I direct black 17, 19, 22, 32, 38, 51, 71; C.I direct yellow 4, 26, 44, 50; C.I direct red 1, 4, 23, 31, 37, 39, 75, 80, 81, 83, 225, 226, 227; C.I direct blue 1, 15, 41, 71, 86, 87, 106, 108, 199, and the like), acid dyes (for example C.I acid black 1, 2, 24, 26, 31, 52, 107, 109, 110, 119, 154; C.I acid yellow 1, 7, 17, 19, 23, 25, 29, 38, 42, 49, 61, 72, 78, 110, 127, 135, 141, 142; C.I acid red 8, 9, 14, 18, 26, 27, 33, 35, 37, 51, 52, 57, 82, 83, 87, 92, 94, 111, 129, 131, 138, 186, 249, 254, 265, 276; C.I acid violet 15, 17, 49; C.I acid blue 1, 3, 7, 9, 15, 22, 23, 25, 40, 41, 43, 62, 78, 83, 90, 93, 100, 103, 104, 112, 113, 158; C.I acid green 3, 9, 16, 25, 27; C.I acid orange 56, and the like), food dyes (such as C.I. food yellow 3, and the like), Malachite green (C.I 4200) Victoria blue FB (C.I. 44045) methyl violet FN (C.I. 42535), rhodamine F4G (C.I. 45160), and rhodamine 6GCP (C.I 45160), and mixtures thereof. Advantageously, the at least one dye comprises an acid dye, more advantageously it consists in an acid dye.

The term “pigment” should be understood as meaning white or colored, mineral or organic particles of any form, which are insoluble in the medium in which they are solubilized, and which are intended to color the solid marking composition. The pigment can be a fluorescent pigment, a mineral pigment a phosphorescent pigment. The pigments are also generally contained in a dispersion, where the grinding down or particle size reduction is accompanied by appropriate dispersants to achieve stable dispersions. The pigment can have a particle size above 10 microns. The pigment is specifically in the form of a pigment dispersion, more specifically selected in the group consisting of pigment black 7 (such as Flexiverse III black 7 by SunChemical®), pigment blue 15:3 (such as APE FREE BL 15:3 DISP by SunChemical®), pigment red 210 (such as Sunsperse® Red 210 by SunChemical®), pigment green 7 (such as Sunsperse Eco green, Flexiverse FD Green, Flexiverse Green 7, Flexiverse HC GRN 7 by SunChemical®), and mixtures thereof.

Specifically, the total content of the coloring agent (c) in the composition according to the disclosure is in the range of 0.1 to 20%, more specifically 0.2 to 15%, still more specifically 0.5 to 10%, even still more specifically 0.7 to 5%, by weight based on the total weight of the composition.

Component (c) has the function of providing color to the mark left on the porous surface when using the composition according to the present disclosure.

The water-based solid marking composition according to the present disclosure may further contains a co-solvent, specifically selected in the group of glycol ethers such as triethylene glycol, polyethylene glycol, diethylene glycol monoethyl ether, diethylene-glycol-mono butyl ether, dipropyleneglycol monobutyl ether, tripropylene glycol monomethyl ether, phenoxyethanol, phenoxypropanol; alcohols, such as phenoxyethanol, phenoxypropanol; linear or branched alcohols in C₁-C₁₅ such as isopropanol, butanol, isobutanol, pentanol, benzyl alcohol, glycerol, diglycerol or polyglycerol; esters such as ethyl acetate or propyl acetate; carbonate esters such as propylene carbonate or ethylene carbonate; ketones such as methylisobutylketone (MIBK), acetone or cyclohexanone, and mixtures thereof. In a preferred embodiment, the co-solvent is a mixture of glycol ethers and linear or branched alcohols in C₁-C₁₅, and more specifically the co-solvent is a mixture of glycerol and glycol ether(s), more specifically a mixture of glycerol and triethylene glycol and/or propylene glycol, even more specifically a mixture of glycerol and triethylene glycol (TEG).

Specifically, the total content of co-solvent(s) in the composition according to the disclosure is in the range of 10 to 90%, specifically 20 to 90%, more specifically 30 to 85%, even more specifically 50 to 80%, by weight based on the total weight of the composition.

The water-based solid marking composition according to the present disclosure may further contains at least one additive known by the skilled person to be usable in water-based composition, in particular in water-based solid marking compositions, specifically selected in the group consisting of an antimicrobial agent, a film-forming agent, a wax, a slip agent, a corrosion inhibitor, an antifoam agent and/or a pH adjusting agent, and mixtures thereof, more specifically the composition according to the disclosure comprises a pH adjusting agent such as triethanolamine.

Specifically, the total content of the at least one additive in the composition according to the disclosure is in the range of 0.01 to 25%, specifically 0.05 to 20%, by weight based on the total weight of the composition.

The solid-marking composition according to the disclosure can be enclosed in a casing, for example made of wood or plastic material. However, the presence of a casing is not mandatory and the composition can be used as such, without any casing and can be therefore self-supported.

The present disclosure also concerns a process of preparation of the water-based solid marking composition according to the disclosure, wherein the process comprises the following successive steps:
a) addition of water and optional co-solvent(s) a at a temperature in the range of 80 to 90° C. specifically with a shear rate in the range of 20 to 25 m/s,
b) addition of component a) at a temperature in the range of 80 to 90° C., specifically with a shear rate in the range of 20 to 25 m/s,
c) addition of component b) at a temperature in the range of 80 to 90° C., specifically with a shear rate in the range of 20 to 25 m/s,
d) addition of component c) at a temperature in the range of 80 to 90° C., specifically with a shear rate in the range of 20 to 25 m/s,
e) giving the water-based solid composition its final shape, such as a stick, more specifically by molding, casting or extruding, and letting the composition cool down to room temperature (23° C.).

In addition, the present disclosure concerns the use of a combination of an alkali metal salt of carboxylic acid having 8 to 36 carbon atoms (a) and a fatty acid amide (b) for improving the writing smoothness and/or the quality of deposit and/or the solidity and/or the stability, more specifically over time, of a water-based solid marking composition.

Components (a) and (b) may be as described above.

In addition to the foregoing, the disclosure also comprises other provisions which will emerge from the additional description which follows, which relates to the preparation of writing ink compositions according to the present disclosure and comparative examples.

### Example 1: Preparation of Water-Based Solid Marking Stick According to the Present Disclosure and a Comparative Composition

A marking stick composition according to the disclosure (Ex 1) and a comparative marking stick composition (without the fatty acid amide: comparative Ex 1) have been prepared. Their ingredients and weight % are indicated in table 1.

TABLE 1

| | Ex 1 | Comparative Ex 1 |
|---|---|---|
| | (according to | (not belonging to |
| | the disclosure) | the disclosure) |
| Chemical name | Amount in wt. % | Amount in wt. % |
| glycerol | 29.3 | 29.3 |
| Triethylene glycol | 35.1 | 37.5 |
| (TEG) | | |
| Sodium stearate | 7.1 | 6.9 |
| Dimethyl | 2.00 | — |
| capramide | | |
| Acid yellow 23 | 1.1 | 1.1 |
| Triethanolamine | 14.9 | 14.9 |
| (TEA) | | |
| Demineralized | Rest (up to 100.0%) | Rest (up to 100.0%) |
| water | | |

### Preparation

The solid marking compositions were prepared by the following process:
a) Addition of water, glycerol, and triethylene glycol at a temperature of 85° C. and mixture agitated at a shear rate of 25 m/s,
b) Addition of sodium stearate at a temperature of 85° C. and mixture agitated at a shear rate of 25 m/s,
c) Addition of dimethyl capramide at a temperature of 85° C. and mixture agitated at a shear rate of 25 m/s,
d) Addition of Acid Yellow 23 and triethanolamine at a temperature of 85° C. and mixture agitated at a shear rate of 25 m/s,
e) Mold the compositions into a final stick shape of diameter: 12.1 mm, length: 50 mm, and letting the composition cool down to room temperature (23° C.).

### Evaluation of Smoothness and Regularity Performances of the Solid Compositions

### Smoothness Performance: Measurement of Smoothness

The smoothness is the ability for the user to have a comfortable feel when applying a writing mark with the composition, and in particular the written mark is easy to make on paper surface. In particular the easiness to perform a deposit when applying the composition (i.e. without using a strong pressure (softness)), as well as the glide on the paper surface (i.e. no feel of friction for the user or scratchy noise) have been evaluated. The assessment has been done on paper 1: Papier Veloute 9000, 90 g/m2, 21×29.7 cm, by Clairefontaine, paper 2: printed paper, 80 g/m2, paper 3: Notebook, 90 g/m2, 21×29.7 cm, by Clairefontaine, according to the following method at 23° C. and 50% relative humidity.

The method is as follows:

Straight lines with a length of 18 cm were drawn by a trained user (i.e. an expert used to evaluate marking compositions) with the solid marking composition on the paper surface (repeated 5 times in order to obtain an average value).

The scoring (i.e. the smoothness efficiency) is defined as follows:

10: Smoothness of the written mark is very efficient: no feeling of hardness for the user, i.e. the composition is soft and can be applied on the paper surface easily without using a strong pressure) and the glide feeling on the paper surface is satisfactory.

5: Smoothness of the written mark is not completely efficient: feeling of hardness for the user, i.e. a higher pressure is needed to apply the composition correctly on the paper surface or the glide is on the surface is moderate).

0: Smoothness of the written mark is not efficient: feeling of scratching for the user, i.e. the composition is hard, meaning that it is difficult to make apply it on the paper surface and a strong pressure is needed and the glide feeling on the paper surface is unsatisfactory, i.e. with a feel of friction).

The results are indicated in Table 2 below.

### Regularity of the Written Mark

The regularity (or quality) of the written mark is the uniformity as well as the quality of the outline of a written mark made by a trained user (i.e. an expert used to evaluate marking compositions) by applying on a paper surface.

In particular, the uniformity of the written mark, such as the presence of blank areas, as well as the quality of the outline of the written mark (such as a good definition of the outline) have been evaluated visually by the naked eye.

The assessment has been done on paper 1: Papier Veloute 9000, 90 g/m2, 21×29.7 cm, by Clairefontaine, paper 2: printed paper, 80 g/m2, paper 3: Notebook, 90 g/m2, 21×29.7 cm, by Clairefontaine, according to the following method at 23° C. and 50% relative humidity.

The method is as follows:

Straight lines with a length of 18 cm were drawn by a trained user with the solid marking composition on the paper surface (repeated 5 times in order to obtain an average value).

The scoring (color regularity of the written mark) is defined as follows:

10: The color of the written mark after application on the paper surface is uniform (i.e. without blank areas or very few blank areas) and has a well-defined outline.

5: The color of the written mark after application on the paper surface is not completely uniform; i.e. several white areas and/or blurs evaluated at different points of the written mark can be observed visually within the written mark, and the outline of the written mark is moderately well defined.

0: The color of the written mark after applying on the paper surface is not uniform (many white areas and/or blurs evaluated at different points of the written mark can be observed visually within the written mark) and the outline of the written mark is not well-defined.

The results are indicated in Table 2 below.

TABLE 2
Results of the smoothness and regularity tests of the solid marking compositions

| | Clairefontaine paper | | | | | |
|---|---|---|---|---|---|---|
| | “smooth paper” | | Printer paper | | Notebook paper | |
| | 90 g/m2 | | 80 g/m2 | | 90 g/m2 | |
| | Color | | Color | | Color | |
| Example | regularity | Smoothness | regularity | Smoothness | regularity | Smoothness |
| Comp Ex 1 | 0 | 5 | 0 | 5 | 0 | 5 |
| Ex 1 | 10 | 10 | 5 | 10 | 10 | 10 |

The written mark made with the marking stick Ex 1 according to the disclosure comprising a fatty acid amid exhibit better results in terms regularity (quality) of the deposit than comparative Ex 1. Thus, the addition of the fatty acid amid has enable to improve the quality of the deposit on paper.

The marking stick Ex 1 according to the disclosure also exhibit a better smoothness than comparative Ex 1, in particular composition of Ex 1 is smooth, easy to apply, and with a good glide feeling.

Also, the written mark of made with the composition of Ex 1 is glossy and the marking stick of Ex 1 was stable over time, in particular during after at least six months storage at room temperature (no crystallization and no exudation phenomenon has been observed).

Evaluation of Transparency of the Solid Compositions and of the Transparency of the Written Mark Made with Solid Compositions of Example 1 and Comparative Example 1

### Transparency of the Solid Sticks

The transparency of the solid sticks of example 1 and comparative example 1 has been evaluated by visual observation by the naked eye.

The scoring (i.e. transparency of the stick) is defined as follows:

[◯]: solid stick is transparent
[/]: solid stick is translucent
[X]: solid stick is opaque

### Transparency of the Written Mark

The transparency of the written mark made on a paper surface with the solid sticks of example 1 and comparative example 1 has been evaluated by:
1. carrying out manual writing with a black ball pen ink (Bic Cristal, medium point 1 mm) on paper 1 (Papier Veloute 9000, 90 g/m2, 21×29.7 cm, by Clairefontaine),
2. then applying the stick composition to be evaluated on the top of this written line made with a ball pen and
3. observing by naked eye if the shape of the writing with the ball pen is visible and identifiable.

The scoring (i.e. transparency of the written mark) is defined as follows:

[◯]: the shape of the ball pen written line can be confirmed.

[X]: the shape of the ball pen written line cannot be confirmed.

The results are indicated in Table 3 below:

TABLE 3

Clairefontaine paper “smooth paper”
90 g/m2

| | Transparency of | Transparency of the |
|---|---|---|
| Example | the Stick | written mark |
| Comp Ex 1 | / | ◯ |
| Ex 1 | / | ◯ |

Thus, both of the marking sticks of Ex 1 according to the disclosure and of comparative Ex 1 are translucent. Besides, both of the written marks made on a paper surface with these two sticks are transparent as the manual writing is still visible after application of the solid marking stick composition.

1. A water-based solid marking composition comprising
a) an alkali metal salt of carboxylic acid having 8 to 36 carbon atoms;
b) a fatty acid amide and
c) a coloring agent.

2. The water-based solid marking composition according to claim 1, wherein the alkali metal salt of carboxylic acid having 8 to 36 carbon atoms (a) is an alkali metal salt of saturated fatty acid having 8 to 36 carbon atoms.

3-15. (canceled)

16. The water-based solid marking composition according to claim 1, wherein the alkali metal salt of carboxylic acid having 8 to 36 carbon atoms (a) is an alkali metal salt of saturated fatty acid having 12 to 28 carbon atoms.

17. The water-based solid marking composition according to claim 1, wherein the alkali metal salt of carboxylic acid having 8 to 36 carbon atoms (a) is sodium stearate.

18. The water-based solid marking composition according to claim 1, wherein the total content of alkali metal salt of carboxylic acid having 8 to 36 carbon atoms (a) is in the range of 0.1 to 20% by weight based on the total weight of the composition.

19. The water-based solid marking composition according to claim 1, wherein the fatty acid amide (b) has the following formula (I)
R₁CONR₂R₃ (I),
in which R₁ represents an alkyl or alkenyl group having from 5 to 18 carbon atoms, the alkyl or alkenyl group being optionally substituted by one or several groups selected among a chloro atom, a fluoro atom, a bromo atom, a nitro group, a nitrile group, an hydroxyl group, a thiol group, a carboxyl group, an ester group having 2 to 6 carbon atom, a C₁₋₂₂-alkoxy group, C₆₋₁₄ aryl group, a C₇-C₂₀ alkaryl group, an amino group, an amino-C₁₋₂₂-alkyl group and an amino-di(C₁₋₂₂-alkyl) group, and R₂ and R₃ independently from each other represent a hydrogen atom or a C₁-C₆ alkyl group, optionally substituted by a hydroxyl group and/or a C₁-C₂₂ alkoxy group.

20. The water-based solid marking composition according to claim 19, wherein at least one of R₂ or R₃ does not represent a hydrogen atom.

21. The water-based solid marking composition according to claim 19, wherein R₂ and R₃ independently from each other represent a C₁-C₆ alkyl group.

22. The water-based solid marking composition according to claim 1, wherein the fatty acid amide (b) is dimethylcapramide.

23. The water-based solid marking composition according to claim 1, wherein the total content of fatty acid amide (b) is in the range of 0.1 to 20% by weight based on the total weight of the composition.

24. The water-based solid marking composition according to claim 1, wherein the total content of fatty acid amide (b) is in the range of 0.1 to 10% by weight based on the total weight of the composition.

25. The water-based solid marking composition according to claim 1, wherein the coloring agent (c) is a pigment or a dye.

26. The water-based solid marking composition according to claim 1, wherein the total content of water is in the range of 1 to 50% by weight based on the total weight of the composition.

27. The water-based solid marking composition according to claim 1, further comprising at least a co-solvent.

28. The water-based solid marking composition according to claim 27, wherein the total content of co-solvent is in the range of 10 to 90% by weight based on the total weight of the composition.

29. The water-based solid marking composition according to claim 1, further comprising at least one additive.

30. The water-based solid marking composition according to claim 29, wherein the total content of additive is in the range of 0.01 to 25% by weight based on the total weight of the composition.

31. The water-based solid marking composition according to claim 1, which is in the form of a crayon, a pastel crayon, a stick, a colored pencil.

32. A process of preparation of the water-based solid marking composition according to claim 1, wherein the process comprises the following successive steps:
A) addition of water and optional co-solvent(s) at a temperature in the range of 80 to 90° C.,
B) addition of component a) at a temperature in the range of 80 to 90° C.,
C) addition of component b) at a temperature in the range of 80 to 90° C.,
D) addition of component c) at a temperature in the range of 80 to 90° C.,
E) giving the water-based solid composition its final shape, and letting the composition cool down to room temperature.

33. A method of using the composition of claim 1 for improving the writing smoothness, the quality of deposit, the solidity, and/or the stability over time of a water-based solid marking composition, comprising:
A) addition of water and optional co-solvent(s) at a temperature in the range of 80 to 90° C.,
B) addition of an alkali metal salt of carboxylic acid having 8 to 36 carbon atoms at a temperature in the range of 80 to 90° C.,
C) addition of a fatty acid amide at a temperature in the range of 80 to 90° C.,
D) addition of a coloring agent at a temperature in the range of 80 to 90° C.,
E) giving the water-based solid composition its final shape, and letting the composition cool down to room temperature.
